(19) United States
(12) Patent Application Publication
(10) Pub. No.: US 2023/0318825 A1
(43) Pub. Date: Oct. 5, 2023

(54) SEPARATELY STORING ENCRYPTION KEYS AND ENCRYPTED DATA IN A HYBRID MEMORY

(71) Applicant: Intel Corporation, Santa Clara, CA (US)

(72) Inventors: Abhishek Anil Sharma, Portland, OR (US); Sagar Suthram, Portland, OR (US); Pushkar Ranade, San Jose, CA (US); Wilfred Gomes, Portland, CA (US)

(21) Appl. No.: 17/708,431

(22) Filed: Mar. 30, 2022

(51) Int. Cl. H04L 9/08; G06F 21/72

(52) U.S. Cl. CPC H04L 9/0894; G06F 21/72; H04L 9/0819

(57) ABSTRACT

In one embodiment, an apparatus includes: at least one core to execute operations on data; a cryptographic circuit to perform cryptographic operations; a static random access memory (SRAM) coupled to the at least one core; and a ferroelectric memory coupled to the at least one core. In response to a read request, the SRAM is to provide an encryption key to the cryptographic circuit and the ferroelectric memory is to provide encrypted data to the cryptographic circuit, the encryption key associated with the encrypted data. Other embodiments are described and claimed.

### BACKGROUND

Modern semiconductor packaging techniques often seek to increase the number of die-to-die connections. Conventional techniques implement a so-called 2.5D solution, utilizing a silicon interposer and through silicon vias (TSVs) to connect die using interconnects with a density and speed typical for integrated circuits in a minimal footprint. However there are complexities in layout and manufacturing techniques. Further, when seeking to embed a memory die in a common package, there can be latencies owing to separation between consuming resources and the memory die as they may be separated from each other by adaptation on different portions of the silicon interposer.

One new memory technology is ferroelectric memory. While this type of memory can provide high capacity, its structure is such that there is a relatively long latency in accessing it. Such delays can undesirably impact performance.

### BRIEF DESCRIPTION OF THE DRAWINGS

FIG. 1 is a block diagram of a package having memory tightly coupled with processing circuitry in accordance with an embodiment.

FIG. 2 is a cross sectional view of a package in accordance with an embodiment.

FIG. 3A is a block diagram of a compute platform in accordance with an embodiment.

FIG. 3B is a cross-sectional view of a memory die in accordance with an embodiment.

FIG. 4 is a flow diagram of a method in accordance with an embodiment.

FIG. 5 is a flow diagram of a method in accordance with another embodiment.

FIG. 6 is a block diagram of an example system with which embodiments can be used.

FIG. 7 is a block diagram of a system in accordance with another embodiment.

FIG. 8 is a block diagram of a system in accordance with another embodiment.

FIG. 9 is a block diagram illustrating an IP core development system used to manufacture an integrated circuit to perform operations according to an embodiment.

### DETAILED DESCRIPTION

In various embodiments, an integrated circuit (IC) package may include multiple dies in stacked relation. More particularly in embodiments, at least one compute die may be adapted on a memory die. In some cases, the memory die may be implemented as a hybrid memory having different memory technologies, such as static random access memory (SRAM) and ferroelectric memory. One or more embodiments may leverage characteristics of these different memory technologies to provide faster latency to stored information with lower power consumption. Of course, such memory die having hybrid memory structures may be separately packaged, in other embodiments.

Still further, the package having multiple dies may be configured in a manner to provide fine-grained memory access by way of localized dense connectivity between compute elements of the compute die and localized banks (or other local portions) of the memory die. This close physical coupling of compute elements to corresponding local portions of the memory die enables the compute elements to locally access local memory portions, in contrast to a centralized memory access system that is conventionally implemented via a centralized memory controller.

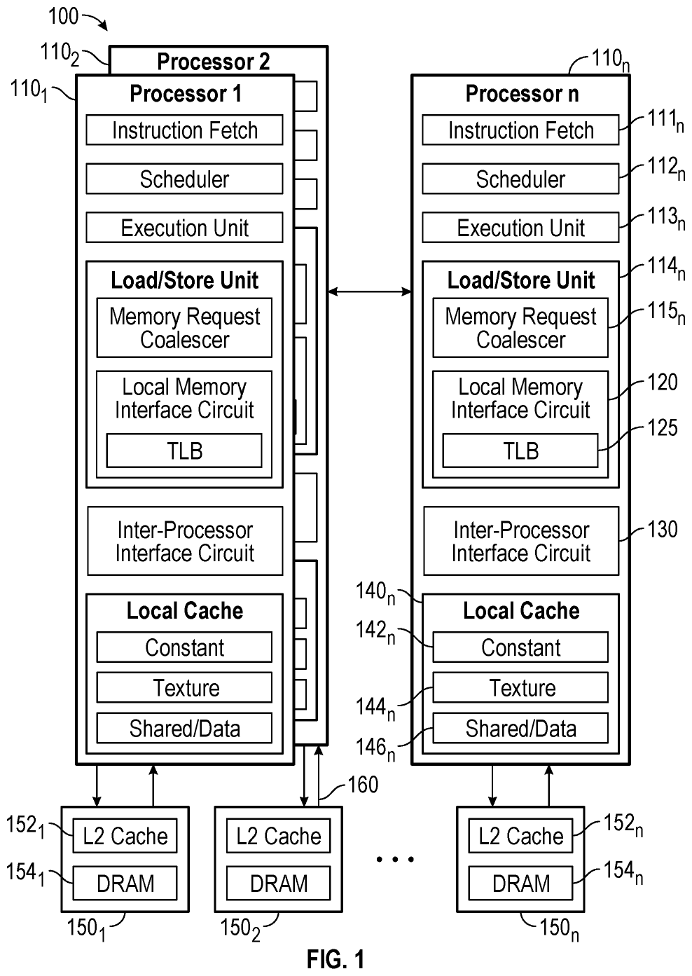

Referring now to FIG. 1, shown is a block diagram of a package having memory tightly coupled with processing circuitry in accordance with an embodiment. As shown in FIG. 1, package 100 includes a plurality of processors 110₁-110ₙ. In the embodiment shown, processors 110 are implemented as streaming processors. However embodiments are not limited in this regard, and in other cases the processors may be implemented as general-purpose processing cores, accelerators such as specialized or fixed function units or so forth. As used herein, the term “core” refers generally to any type of processing circuitry that is configured to execute instructions, tasks and/or workloads, namely to process data.

In the embodiment of FIG. 1, processors 110 each individually couple directly to corresponding portions of a memory 150, namely memory portions 150₁-150ₙ. As such, each processor 110 directly couples to a corresponding local portion of memory 150 without a centralized interconnection network therebetween. In one or more embodiments described herein, this direct coupling may be implemented by stacking multiple die within package 100. For example, processors 110 may be implemented on a first die and memory 150 may be implemented on at least one other die, where these dies may be stacked on top of each other, as will be described more fully below. By “direct coupling” it is meant that a processor (core) is physically in close relation to a local portion of memory in a non-centralized arrangement so that the processor (core) has access only to a given local memory portion and without communicating through a memory controller or other centralized controller.

As seen, each instantiation of processor 110 may directly couple to a corresponding portion of memory 150 via interconnects 160. Although different physical interconnect structures are possible, in many cases, interconnects 160 may be implemented by one or more of conductive pads, bumps or so forth. Each processor 115 may include TSVs that directly couple to TSVs of a corresponding local portion of memory 150. In such arrangements, interconnects 160 may be implemented as bumps or hybrid bonding or other bumpless technique.

Memory 150 may, in one or more embodiments, include a level 2 (L2) cache 152 and a dynamic random access memory (DRAM) 154. As illustrated, each portion of memory 150 may include one or more banks or other portions of DRAM 154 associated with a corresponding processor 110. In one embodiment, each DRAM portion 154 may have a width of at least 1024 words. Of course other widths are possible. Also while a memory hierarchy including both an L2 cache and DRAM is shown in FIG. 1, it is possible for an implementation to provide only DRAM 154 without the presence of an L2 cache (at least within memory 150). This is so, as DRAM 154 may be configured to operate as a cache, as it may provide both spatial and temporal locality for data to be used by its corresponding processor 110. This is particularly so when package 100 is included in a system having a system memory (e.g., implemented as dual-inline memory modules (DIMMs) or other volatile or non-volatile memory). In other cases, such as a DRAM-less system, there may be multiple memory dies, including at least one die having local memory portions in accordance with an embodiment, and possibly one or more other memory die having conventional DRAM to act as at least a portion of a system memory. As an example, one memory die may be configured as a cache memory and another memory die may be configured as a system memory. In such DRAM-less system, DRAM 154 may be a system memory for the system in which package 100 is included.

With embodiments, package 100 may be implemented within a given system implementation, which may be any type of computing device that is a shared DRAM-less system, by using memory 150 as a flat memory hierarchy. Such implementations may be possible, given the localized dense connectivity between corresponding processors 110 and memory portions 150 that may provide for dense local access on a fine-grained basis. In this way, such implementations may rely on physically close connections to localized memories 150, rather than a centralized access mechanism, such as a centralized memory controller of a processor. Further, direct connection occurs via interconnects 160 without a centralized interconnection network.

Still with reference to FIG. 1, each processor 110 may include an instruction fetch circuit 111 that is configured to fetch instructions and provide them to a scheduler 112. Scheduler 112 may be configured to schedule instructions for execution on one or more execution circuits 113, which may include arithmetic logic units (ALUs) and so forth to perform operations on data in response to decoded instructions, which may be decoded in an instruction decoder, either included within processor 110 or elsewhere within an SoC or another processor.

As further shown in FIG. 1, processor 110 also may include a load/store unit 114 that includes a memory request coalescer 115. Load/store unit 114 may handle interaction with corresponding local memory 150. To this end, each processor 110 further may include a local memory interface circuit 120 that includes a translation lookaside buffer (TLB) 125. In other implementations local memory interface circuit 120 may be separate from load/store unit 114.

In embodiments herein, TLB 125 may be configured to operate on only a portion of an address space, namely that portion associated with its corresponding local memory 150. To this end, TLB 125 may include data structures that are configured for only such portion of an entire address space. For example, assume an entire address space is 64 bits corresponding to a 64-bit addressing scheme. Depending upon a particular implementation and sizing of an overall memory and individual memory portions, TLB 125 may operate on somewhere between approximately 10 and 50 bits.

Still with reference to FIG. 1, each processor 110 further includes a local cache 140 which may be implemented as a level 1 (L1) cache. Various data that may be frequently and/or recently used within processor 110 may be stored within local cache 140. In the illustration of FIG. 1, exemplary specific data types that may be stored within local cache 140 include constant data 142, texture data 144, and shared/data 146. Note that such data types may be especially appropriate when processor 110 is implemented as a graphics processing unit (GPU). Of course other data types may be more appropriate for other processing circuits, such as general-purpose processing cores or other specialized processing units.

Still referring to FIG. 1, each processor 110 may further include an inter-processor interface circuit 130. Interface circuit 130 may be configured to provide communication between a given processor 110 and its neighboring processors, e.g., a nearest neighbor on either side of processor 130. Although embodiments are not limited in this regard, in one or more embodiments inter-processor interface circuit 130 may implement a message passing interface (MPI) to provide communication between neighboring processors. While shown at this high level in the embodiment of FIG. 1, many variations and alternatives are possible. For example, more dies may be present in a given package, including multiple memory dies that form one or more levels of a memory hierarchy and additional compute, interface, and/or controller dies.

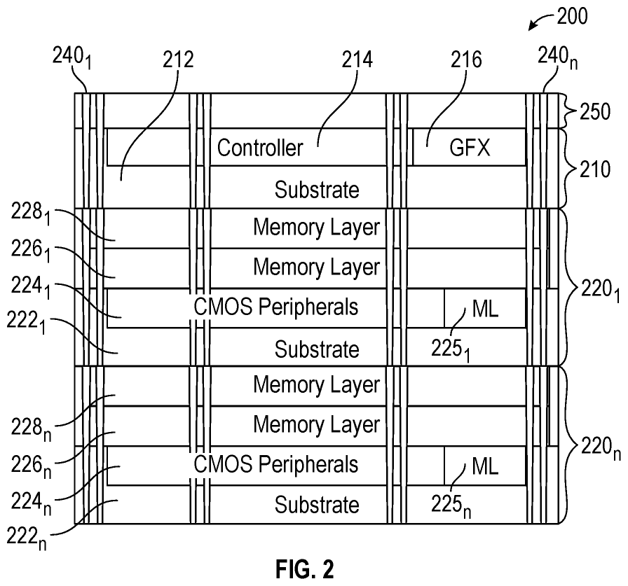

Referring now to FIG. 2, shown is a cross sectional view of a package in accordance with an embodiment. As shown in FIG. 2, package 200 is a multi-die package including a set of stacked die, namely a first die 210, which may be a compute die and multiple memory die 220₁ and 220₂. With this stacked arrangement, compute die 210 may be stacked above memory die 220 such that localized dense connectivity is realized between corresponding portions of memory die 220 and compute die 210. As further illustrated, a package substrate 250 may be present onto which the stacked dies may be adapted. In an embodiment, compute die 210 may be adapted at the top of the stack to improve cooling.

As further illustrated in FIG. 2, physical interconnection between circuitry present on the different die may be realized by TSVs 240₁-240ₙ (each of which may be formed of independent TSVs of each die). In this way, individual memory cells of a given portion may be directly coupled to circuitry present within compute die 210. Note further that in FIG. 2, in the cross-sectional view, only circuitry of a single processing circuit and a single memory portion is illustrated. As shown, with respect to compute die 210, a substrate 212 is provided in which controller circuitry 214 and graphics circuitry 216 is present.

With reference to memory die 220, a substrate 222 is present in which complementary metal oxide semiconductor (CMOS) peripheral circuitry 224 may be implemented, along with memory logic (ML) 225, which may include localized memory controller circuitry and/or cache controller circuitry. In certain implementations, CMOS peripheral circuitry 224 may include encryption/decryption circuitry, in-memory processing circuitry or so forth. As further illustrated, each memory die 220 may include multiple layers of memory circuitry. In one or more embodiments, there may be a minimal distance between CMOS peripheral circuitry 224 and logic circuitry (e.g., controller circuitry 214 and graphics circuitry 216) of compute die 210, such as less than one micron.

As shown, memory die 220 may include memory layers 226, 228. While shown with two layers in this example, understand that more layers may be present in other implementations. In this high level illustration in FIG. 2, one of these memory layers may be implemented as an SRAM while the other memory layer may be implemented as a ferroelectric memory (note that each of these layers may more particularly be implemented with multiple layers of a semiconductor stack). In one or more embodiments, each portion of memory die 220 provides a locally dense full width storage capacity for a corresponding locally coupled processor. Note that memory die 220 may be implemented in a manner in which the memory circuitry of layers 226, 228 may be implemented with backend of line (BEOL) techniques. While shown at this high level in FIG. 2, many variations and alternatives are possible.

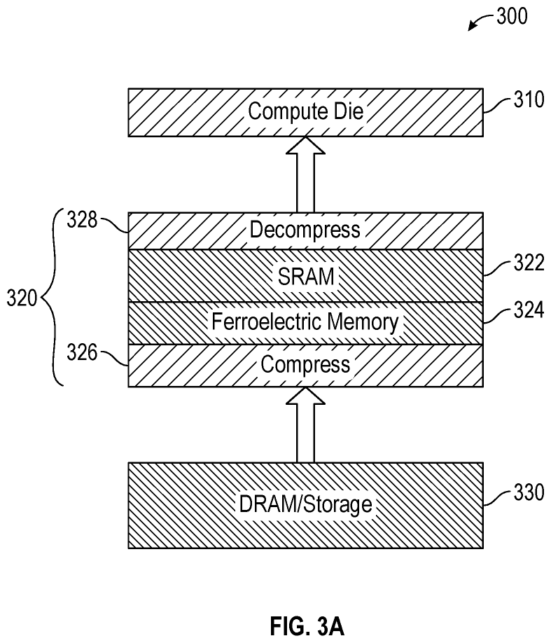

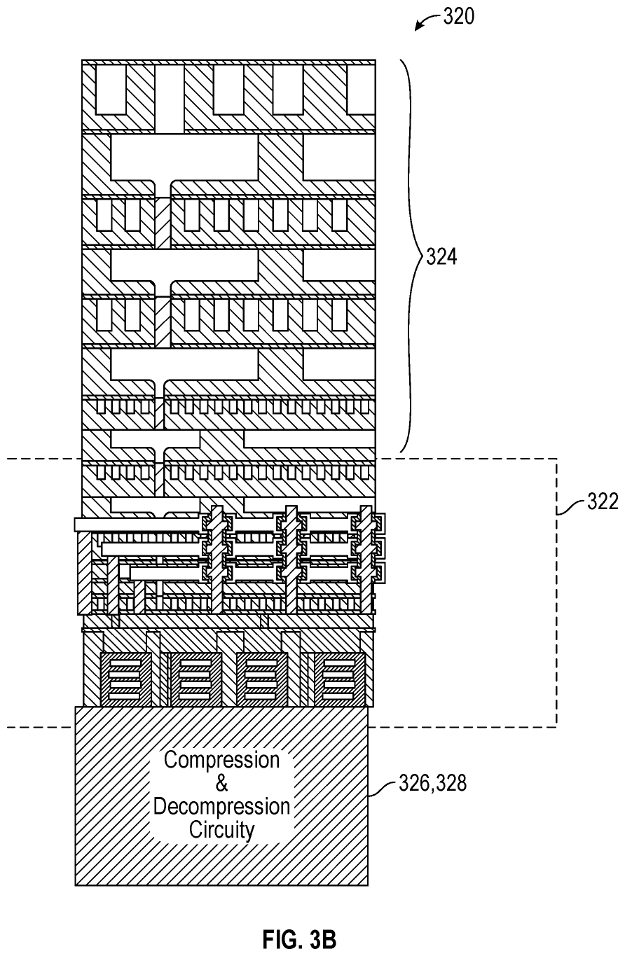

Referring now to FIG. 3A, shown is a block diagram of a compute platform in accordance with an embodiment. As shown in FIG. 3A, a compute platform 300 is illustrated to show at least portions of circuitry present within the system. In the high level view shown, all of the circuitry may be present in a single IC package or may be implemented in multiple IC packages and coupled together, e.g., by a circuit board or other interconnection.

In any case in the high level shown, a compute die 310 is present. In one or more implementations, compute die 310 may be one of multiple processors such as a SoC, GPU or so forth. Compute die 310 is in communication with a memory die 320. In the high level view shown in FIG. 3A, memory die 320 includes hybrid memory technologies, namely a SRAM 322 and a ferroelectric memory 324. While these different memory technologies are shown as single layer constructs in the high level of FIG. 3, it is possible for one or both to be formed of multiple layers.

As further shown, memory die 320 also includes computation circuitry in the form of a compression circuit 326 and a decompression circuit 328. While shown as being implemented within memory die 320, in other cases this circuitry may be present in compute die 310. As further illustrated, a DRAM or other storage die 330 couples to memory die 320, and may provide for system memory or other mass storage. In some implementations, storage 330 may be implemented within a multi-chip package with the other dies, while in other implementations storage 330 may be separately packaged.

By virtue of the hybrid memory technologies present within memory die 320, certain latency of access to information stored in ferroelectric memory 324 may be hidden by leveraging faster access to SRAM 322. For example, encryption keys used for encrypting/decrypting information may be stored in SRAM 322, rather than being stored within ferroelectric memory 324 along with encrypted information itself. In this way, such encryption keys and/or other encryption/compression control information may be separately accessed and provided to decryption/decompression circuitry in advance. As a result, the cryptographic/compression circuitry can configure itself to be ready when the encrypted/compressed information is thereafter received from ferroelectric memory 324. In one example, encryption keys may be stored in one or more columns of SRAM 322 that may be faster accessed.

In certain implementations, the encrypted data may be homomorphically encrypted, such that certain operations may be directly performed on the encrypted data. Of course, embodiments are not limited to homomorphic encryption. In one or more embodiments, data stored in one or more of SRAM 322 and ferroelectric memory 324 may be both encrypted and compressed. In other implementations, such data may be encrypted but not compressed, and still further it is possible for the data to be compressed and unencrypted. Still further, the data may also be protected by way of error correction information, such as error correction coding (ECC) bits. For convenience herein, discussion centers around storage of encrypted data in one portion of a hybrid memory and concomitant storage of encryption keys in a separate portion of the hybrid memory. This discussion applies equally to separate storage of compressed data and compression control information, as well as separate storage of error correction information from the data.

Referring now to FIG. 3B, shown is a cross-sectional view of a memory die in accordance with an embodiment. As shown in FIG. 3B, memory die 320 includes hybrid memory technologies, including SRAM 322 and ferroelectric memory 324. In addition, compression/decompression circuitry 326, 328 is also present. In this cross-sectional view illustration, compression/decompression circuitry 326, 328 may be implemented in one or more CMOS layers formed, e.g., on a silicon or other semiconductor substrate. In turn, SRAM 322 may be adapted on this circuitry, and may be formed of multiple layers arranged as SRAM arrays.

In turn, ferroelectric memory 324 may be adapted on SRAM 322. In an embodiment, ferroelectric memory 324 may be implemented as a 1 transistor-4 capacitor (1T-4C) ferroelectric memory. In general, SRAM 322 may have much faster access capabilities than ferroelectric memory 324. Accordingly, latency of access to ferroelectric memory 324 may be hidden, at least in part, by using SRAM 322 to store encryption keys and/or other encryption/compression control information. While shown at this high level in FIG. 3B, understand that variations and alternatives are possible. For example, compression/decompression circuitry 326, 328 may further include cryptographic circuitry such as an Advanced Encryption Standard (AES) engine, and still further may include error correction circuitry.

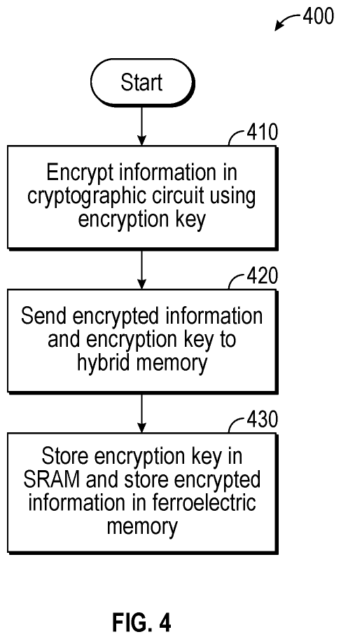

Referring now to FIG. 4, shown is a flow diagram of a method in accordance with an embodiment. As shown in FIG. 4, method 400 is a method for performing a write operation to a hybrid memory in accordance with an embodiment. As such, method 400 may be performed by hardware circuitry present in the hybrid memory, along with cryptographic circuitry. This cryptographic circuitry may be present in the hybrid memory or in a compute circuit coupled to the hybrid memory. Such hardware circuitry, alone and/or in combination with firmware and/or software may execute method 400.

As illustrated, method 400 begins by encrypting information in the cryptographic circuit using an encryption key (block 410). Depending upon implementation, this operation may be performed within an SoC cryptographic circuit such as an AES engine prior to a write request being sent to the hybrid memory. Or in a case where cryptographic circuitry is present in the hybrid memory, the encryption operation may be performed in response to receipt of the write request and associated information to be encrypted and stored.

In any event, control next passes to block 420 where the encrypted information and associated encryption key may be sent to the hybrid memory. Thereafter at block 430, the hybrid memory may separately store the encryption key and the associated encrypted data. Specifically, the encryption key is stored in SRAM of the hybrid memory while the encrypted information is stored in ferroelectric memory of the hybrid memory. In one or more embodiments, the hybrid memory may further store a table or other indexing structure to map the location of the encryption key within the SRAM to the location in the ferroelectric memory of the encrypted information. This mapping may then be accessed in response to a read request to enable the encryption key and the corresponding encrypted information to be read. While shown at this high level in the embodiment of FIG. 4, variations and alternatives are possible. For example, similar techniques can be used to compress data and store compression control information in a separate portion of a hybrid memory than the compressed data (e.g., compressed data in ferroelectric memory and compression control information in SRAM).

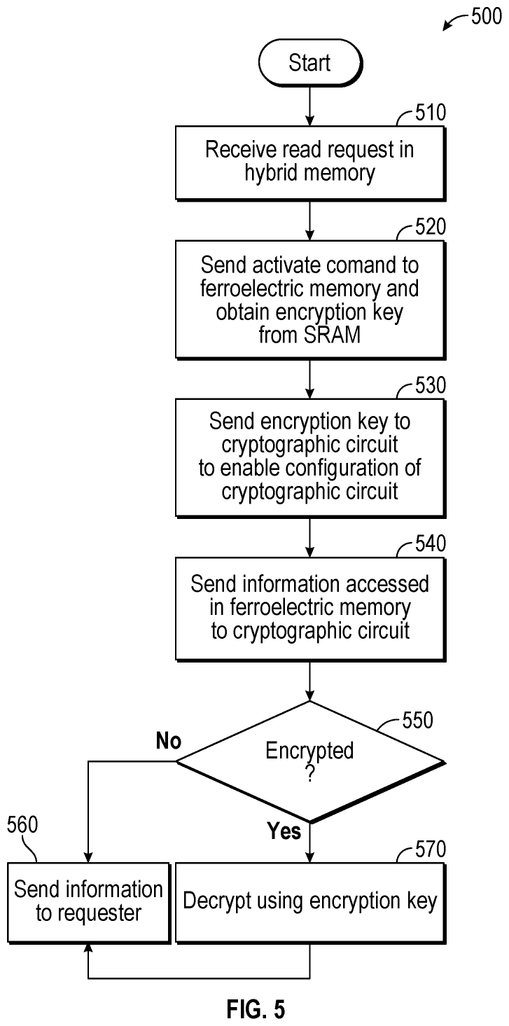

Referring now to FIG. 5, shown is a flow diagram of another method in accordance with an embodiment. As shown in FIG. 5, method 500 is a method for performing a read operation to a hybrid memory in accordance with an embodiment. As such, method 500 may be performed by hardware circuitry present in the hybrid memory, along with cryptographic circuitry; as discussed above, such hardware circuitry, alone and/or in combination with firmware and/or software may execute method 500.

Method 500 begins by receiving a read request in the hybrid memory (block 510). In response to this read request, the hybrid memory sends an activate command to the ferroelectric memory and obtains the encryption key from the SRAM (block 520). Next at block 530, the hybrid memory sends the encryption key to the cryptographic circuit to enable appropriate configuration of the cryptographic circuit. For example, the cryptographic circuit may populate an AES engine with the encryption key so that it can immediately begin decryption upon receipt of the encrypted information.

Note that in some embodiments, additional information stored with the encryption key (in the SRAM) also may be sent to the cryptographic circuit. Such information may include control information to indicate whether the cryptographic circuit is to be enabled for a given read request. Thus this control information may include at least an enable indicator or bit. In certain implementations additional control information such as encryption mode or so forth also may be provided. Note that the cryptographic circuit may use this information in configuring its circuitry in preparation for a decryption operation.

Also when this control information indicates that the incoming information is not encrypted, the cryptographic circuit may potentially be powered down to reduce power consumption, and a fabric or other switching circuitry can be configured to directly send incoming information from the hybrid memory (e.g., from the ferroelectric memory) to a requestor such as a core and not to the cryptographic circuit, as the cryptographic circuit may be powered down.

Still with reference to FIG. 5, at block 540 the information obtained from the ferroelectric memory in response to the activate command may be sent to the cryptographic circuit. Note the different latencies in sending of the encryption key (and associated control information, potentially) and the encrypted information. Although embodiments are not limited in this regard, the encryption key may be provided to the cryptographic circuit with minimal latency, e.g., within a single or few cycles, while the encrypted information may be obtained and sent with a much higher latency, e.g., on the order of approximately 30 or more cycles, owing to the differences in the different memory types.

Referring still to FIG. 5, control next passes to diamond 550 where it may be determined whether the incoming information is encrypted. If not, the information may be directly provided to the requester (block 560). Otherwise if the information is encrypted, control passes to block 570 where the information may be decrypted using the encryption key previously sent and used for configuring the cryptographic circuit. Thereafter the decrypted information is sent to the requester (block 570). While shown with this high level in the embodiment of FIG. 5, many variations and alternatives are possible, such as for handling data that is further compressed.

Packages in accordance with embodiments can be incorporated in many different system types, ranging from small portable devices such as a smartphone, laptop, tablet or so forth, to larger systems including client computers, server computers and datacenter systems.

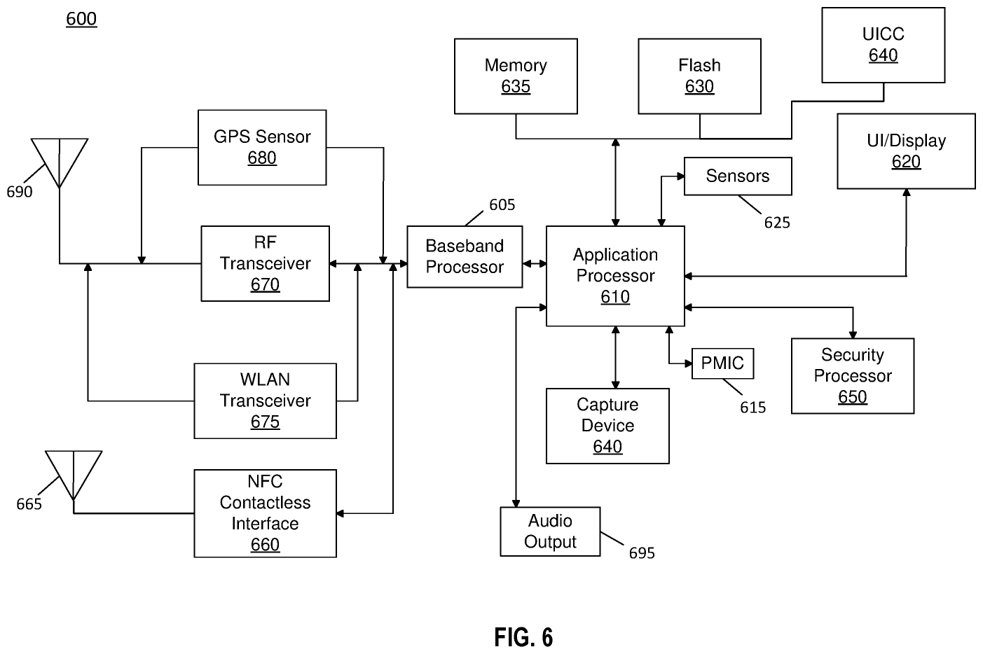

Referring now to FIG. 6, shown is a block diagram of an example system with which embodiments can be used. As seen, system 600 may be a smartphone or other wireless communicator. A baseband processor 605 is configured to perform various signal processing with regard to communication signals to be transmitted from or received by the system. In turn, baseband processor 605 is coupled to an application processor 610, which may be a main CPU of the system to execute an OS and other system software, in addition to user applications such as many well-known social media and multimedia apps. Application processor 610 may further be configured to perform a variety of other computing operations for the device.

In turn, application processor 610 can couple to a user interface/display 620, e.g., a touch screen display. In addition, application processor 610 may couple to a memory system including a non-volatile memory, namely a flash memory 630 and a memory 635, which may include hybrid memory technologies as described herein. In embodiments herein, a package may include multiple dies including at least processor 610 and memory 635, which may be stacked and configured as described herein. As further seen, application processor 610 further couples to a capture device 640 such as one or more image capture devices that can record video and/or still images.

Still referring to FIG. 6, a universal integrated circuit card (UICC) 640 comprising a subscriber identity module and possibly a secure storage and cryptoprocessor is also coupled to application processor 610. System 600 may further include a security processor 650 that may couple to application processor 610. A plurality of sensors 625 may couple to application processor 610 to enable input of a variety of sensed information such as accelerometer and other environmental information. An audio output device 695 may provide an interface to output sound, e.g., in the form of voice communications, played or streaming audio data and so forth.

As further illustrated, a near field communication (NFC) contactless interface 660 is provided that communicates in a NFC near field via an NFC antenna 665. While separate antennae are shown in FIG. 6, understand that in some implementations one antenna or a different set of antennae may be provided to enable various wireless functionality.

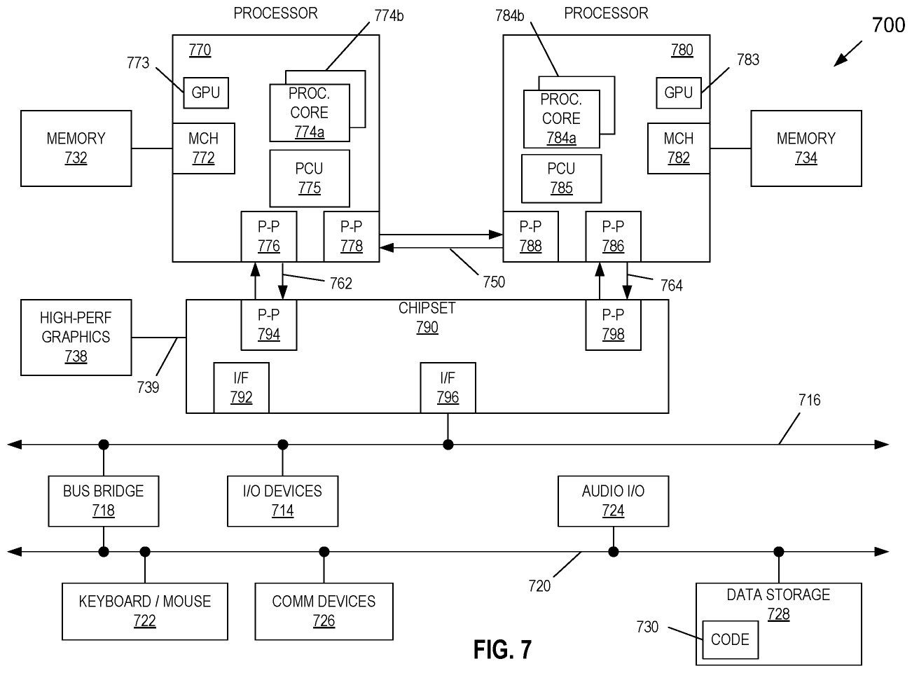

Embodiments may be implemented in other system types such as client or server systems. Referring now to FIG. 7, shown is a block diagram of a system in accordance with another embodiment. As shown in FIG. 7, multiprocessor system 700 is a point-to-point interconnect system, and includes a first processor 770 and a second processor 780 coupled via a point-to-point interconnect 750. As shown in FIG. 7, each of processors 770 and 780 may be multicore processors, including first and second processor cores (i.e., processors 774a and 774b and processor cores 784a and 784b), although potentially many more cores may be present in the processors. In addition, each of processors 770 and 780 also may include a graphics processor unit (GPU) 773, 783 to perform graphics operations. Each of the processors can include a power control unit (PCU) 775, 785 to perform processor-based power management.

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of system memory (e.g., having hybrid memory technologies as described herein) locally attached to the respective processors. In embodiments herein, one or more packages may include multiple dies including at least processor 770 and memory 732 (e.g.), which may be stacked and configured as described herein.

First processor 770 and second processor 780 may be coupled to a chipset 790 via P-P interconnects 762 and 764, respectively. As shown in FIG. 7, chipset 790 includes P-P interfaces 794 and 798. Furthermore, chipset 790 includes an interface 792 to couple chipset 790 with a high performance graphics engine 738, by a P-P interconnect 739. In turn, chipset 790 may be coupled to a first bus 716 via an interface 796. As shown in FIG. 7, various input/output (I/O) devices 714 may be coupled to first bus 716, along with a bus bridge 718 which couples first bus 716 to a second bus 720. Various devices may be coupled to second bus 720 including, for example, a keyboard/mouse 722, communication devices 726 and a data storage unit 728 such as a disk drive or other mass storage device which may include code 730, in one embodiment. Further, an audio I/O 724 may be coupled to second bus 720.

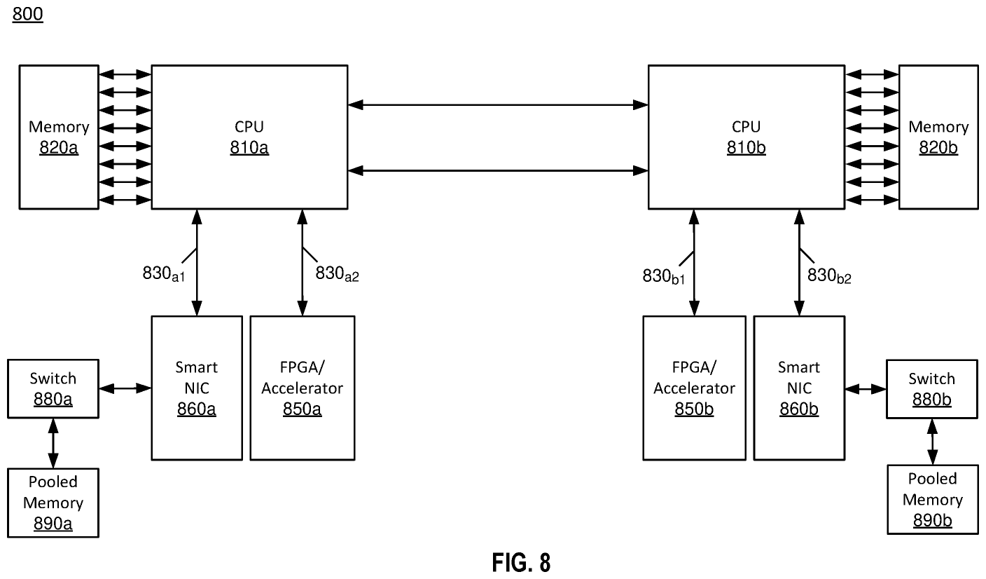

Referring now to FIG. 8, shown is a block diagram of a system 800 in accordance with another embodiment. As shown in FIG. 8, system 800 may be any type of computing device, and in one embodiment may be a datacenter system. In the embodiment of FIG. 8, system 800 includes multiple CPUs 810a,b that in turn couple to respective memories 820a,b which in embodiments may include hybrid memory technologies as described herein. Note that CPUs 810 may couple together via an interconnect system 815 implementing a coherency protocol. In embodiments herein, one or more packages may include multiple dies including at least CPU 810 and memory 820 (e.g.), which may be stacked and configured as described herein.

To enable coherent accelerator devices and/or smart adapter devices to couple to CPUs 810 by way of potentially multiple communication protocols, a plurality of interconnects 830a1-b2 may be present.

In the embodiment shown, respective CPUs 810 couple to corresponding field programmable gate arrays (FPGAs)/accelerator devices 850a,b (which may include GPUs, in one embodiment). In addition CPUs 810 also couple to smart NIC devices 860a,b. In turn, smart NIC devices 860a,b couple to switches 880a,b that in turn couple to a pooled memory 890a,b such as a persistent memory.

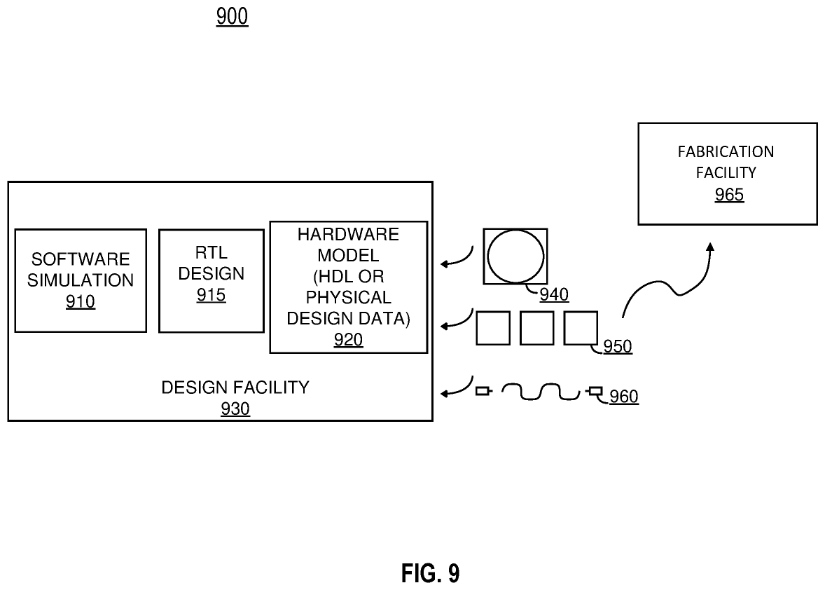

FIG. 9 is a block diagram illustrating an IP core development system 900 that may be used to manufacture integrated circuit dies that can in turn be stacked to realize multi-die packages according to an embodiment. The IP core development system 900 may be used to generate modular, re-usable designs that can be incorporated into a larger design or used to construct an entire integrated circuit (e.g., an SoC integrated circuit). A design facility 930 can generate a software simulation 910 of an IP core design in a high level programming language (e.g., C/C++). The software simulation 910 can be used to design, test, and verify the behavior of the IP core. A register transfer level (RTL) design can then be created or synthesized from the simulation model. The RTL design 915 is an abstraction of the behavior of the integrated circuit that models the flow of digital signals between hardware registers, including the associated logic performed using the modeled digital signals. In addition to an RTL design 915, lower-level designs at the logic level or transistor level may also be created, designed, or synthesized. Thus, the particular details of the initial design and simulation may vary.

The RTL design 915 or equivalent may be further synthesized by the design facility into a hardware model 920, which may be in a hardware description language (HDL), or some other representation of physical design data. The HDL may be further simulated or tested to verify the IP core design. The IP core design can be stored for delivery to a third party fabrication facility 965 using non-volatile memory 940 (e.g., hard disk, flash memory, or any non-volatile storage medium). Alternately, the IP core design may be transmitted (e.g., via the Internet) over a wired connection 950 or wireless connection 960. The fabrication facility 965 may then fabricate an integrated circuit that is based at least in part on the IP core design. The fabricated integrated circuit can be configured to be implemented in a package and perform operations in accordance with at least one embodiment described herein.

The following examples pertain to further embodiments.

In one example, an apparatus comprises: at least one core to execute operations on data; a cryptographic circuit to perform cryptographic operations; a SRAM coupled to the at least one core; and a ferroelectric memory coupled to the at least one core. In response to a read request: the SRAM is to provide an encryption key to the cryptographic circuit; and the ferroelectric memory is to provide encrypted data to the cryptographic circuit, the encryption key associated with the encrypted data.

In an example, the cryptographic circuit is to receive the encryption key in advance of receiving the encrypted data.

In an example, the cryptographic circuit is to configure a decryption engine of the cryptographic circuit based at least in part on the encryption key.

In an example, the cryptographic circuit is to receive the encryption key with a first latency and receive the encrypted data with a second latency, the second latency greater than the first latency.

In an example, the apparatus comprises a multi-die package comprising: a first die having the at least one core; and a second die comprising a hybrid memory having the SRAM and the ferroelectric memory.

In an example, the second die further comprises the cryptographic circuit.

In an example, the second die further comprises: a compression circuit to compress data into compressed data; and a decompression circuit to decompress the compressed data.

In an example, the second die comprises: a substrate; one or more CMOS layers adapted on the substrate, the one or more CMOS layers comprising the cryptographic circuit; the SRAM formed above the one or more CMOS layers, where the SRAM has a first access latency; and the ferroelectric memory formed above the SRAM, where the ferroelectric memory has a second access latency greater than the first access latency.

In an example, the SRAM is further to send control information to the cryptographic circuit to indicate that the cryptographic circuit is to be enabled for the decryption of the encrypted data.

In another example, a method comprises: receiving, in a hybrid memory comprising a SRAM and a ferroelectric memory, a read request; in response to the read request, obtaining an encryption key from the SRAM and obtaining encrypted data from the ferroelectric memory, the encryption key associated with the encrypted data; and sending the encryption key to a cryptographic circuit prior to sending the encrypted data to the cryptographic circuit, to enable configuration of the cryptographic circuit for decryption of the encrypted data in advance of receipt of the encrypted data.

In an example, the method further comprises sending the encryption key to the cryptographic circuit with a first latency and sending the encrypted data to the cryptographic circuit with a second latency, the second latency greater than the first latency.

In an example, the method further comprises: receiving the encryption key and the encrypted data in the hybrid memory; storing the encryption key in the SRAM; and storing the encrypted data in the ferroelectric memory.

In an example, the method further comprises storing a mapping to associate the encryption key stored in the SRAM with the encrypted data stored in the ferroelectric memory.

In an example, the method further comprises storing the encryption key in a first column of the SRAM, the first column storing a plurality of encryption keys each associated with different encrypted data stored in the ferroelectric memory.

In an example, sending the encryption key to the cryptographic circuit further comprises sending control information with the encryption key to indicate that the cryptographic circuit is to be enabled for the decryption of the encrypted data.

In an example, the method further comprises: receiving, in the hybrid memory, a second read request; in response to the second read request, obtaining second control information from the SRAM, the second control information to indicate that the second data is unencrypted; and sending the second control information to the cryptographic circuit to indicate that the second data is unencrypted.

In an example, the method further comprises, based at least in part on the second control information, performing at least one of: powering down the cryptographic circuit; and sending the second data directly from the ferroelectric memory to a requester without sending the second data to the cryptographic circuit.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In yet another example, a package comprises: a first die having one or more cores; and a second die comprising a hybrid memory. The hybrid memory may include: a SRAM; and a ferroelectric memory. In response to a read request: the SRAM is to provide an encryption key to a cryptographic circuit; and the ferroelectric memory is to provide encrypted data to the cryptographic circuit, the encryption key associated with the encrypted data.

In an example, the package further comprises the cryptographic circuit, where the cryptographic circuit is to receive the encryption key with a first latency and receive the encrypted data with a second latency, the second latency greater than the first latency.

In an example, the package further comprises a compression circuit, where the SRAM is further to provide compression control information to the compression circuit, the compression circuit to configure a decompression circuit of the compression circuit based at least in part on the compression control information, the compression control information associated with the encrypted data, where the encrypted data is compressed.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
at least one core to execute operations on data;
a cryptographic circuit to perform cryptographic operations;
a static random access memory (SRAM) coupled to the at least one core; and
a ferroelectric memory coupled to the at least one core,
wherein in response to a read request:
the SRAM is to provide an encryption key to the cryptographic circuit; and
the ferroelectric memory is to provide encrypted data to the cryptographic circuit, the encryption key associated with the encrypted data.

2. The apparatus of claim 1, wherein the cryptographic circuit is to receive the encryption key in advance of receiving the encrypted data.

3. The apparatus of claim 2, wherein the cryptographic circuit is to configure a decryption engine of the cryptographic circuit based at least in part on the encryption key.

4. The apparatus of claim 1, wherein the cryptographic circuit is to receive the encryption key with a first latency and receive the encrypted data with a second latency, the second latency greater than the first latency.

5. The apparatus of claim 1, wherein the apparatus comprises a multi-die package comprising:
a first die having the at least one core; and
a second die comprising a hybrid memory having the SRAM and the ferroelectric memory.

6. The apparatus of claim 5, wherein the second die further comprises the cryptographic circuit.

7. The apparatus of claim 5, wherein the second die further comprises:
a compression circuit to compress data into compressed data; and
a decompression circuit to decompress the compressed data.

8. The apparatus of claim 5, wherein the second die comprises:
a substrate;
one or more complementary metal oxide semiconductor (CMOS) layers adapted on the substrate, the one or more CMOS layers comprising the cryptographic circuit;
the SRAM formed above the one or more CMOS layers, wherein the SRAM has a first access latency; and
the ferroelectric memory formed above the SRAM, wherein the ferroelectric memory has a second access latency greater than the first access latency.

9. The apparatus of claim 1, wherein the SRAM is further to send control information to the cryptographic circuit to indicate that the cryptographic circuit is to be enabled for the decryption of the encrypted data.

10. A method comprising:
receiving, in a hybrid memory comprising a static random access memory (SRAM) and a ferroelectric memory, a read request;
in response to the read request, obtaining an encryption key from the SRAM and obtaining encrypted data from the ferroelectric memory, the encryption key associated with the encrypted data; and
sending the encryption key to a cryptographic circuit prior to sending the encrypted data to the cryptographic circuit, to enable configuration of the cryptographic circuit for decryption of the encrypted data in advance of receipt of the encrypted data.

11. The method of claim 10, further comprising sending the encryption key to the cryptographic circuit with a first latency and sending the encrypted data to the cryptographic circuit with a second latency, the second latency greater than the first latency.

12. The method of claim 10, further comprising:
receiving the encryption key and the encrypted data in the hybrid memory;
storing the encryption key in the SRAM; and
storing the encrypted data in the ferroelectric memory.

13. The method of claim 12, further comprising storing a mapping to associate the encryption key stored in the SRAM with the encrypted data stored in the ferroelectric memory.

14. The method of claim 10, further comprising storing the encryption key in a first column of the SRAM, the first column storing a plurality of encryption keys each associated with different encrypted data stored in the ferroelectric memory.

15. The method of claim 10, wherein sending the encryption key to the cryptographic circuit further comprises sending control information with the encryption key to indicate that the cryptographic circuit is to be enabled for the decryption of the encrypted data.

16. The method of claim 10, further comprising:
receiving, in the hybrid memory, a second read request;
in response to the second read request, obtaining second control information from the SRAM, the second control information to indicate that the second data is unencrypted; and
sending the second control information to the cryptographic circuit to indicate that the second data is unencrypted.

17. The method of claim 16, further comprising, based at least in part on the second control information, performing at least one of:
powering down the cryptographic circuit; and
sending the second data directly from the ferroelectric memory to a requester without sending the second data to the cryptographic circuit.

18. A package comprising:
a first die having one or more cores; and
a second die comprising a hybrid memory, the hybrid memory comprising:
a static random access memory (SRAM); and
a ferroelectric memory,
wherein in response to a read request:
the SRAM is to provide an encryption key to a cryptographic circuit; and
the ferroelectric memory is to provide encrypted data to the cryptographic circuit, the encryption key associated with the encrypted data.

19. The package of claim 18, further comprising the cryptographic circuit, wherein the cryptographic circuit is to receive the encryption key with a first latency and receive the encrypted data with a second latency, the second latency greater than the first latency.

20. The package of claim 18, further comprising a compression circuit, wherein the SRAM is further to provide compression control information to the compression circuit, the compression circuit to configure a decompression circuit of the compression circuit based at least in part on the compression control information, the compression control information associated with the encrypted data, wherein the encrypted data is compressed.
